(19) United States
(12) Patent Application Publication
(10) Pub. No.: US 2019/0050851 A1
(43) Pub. Date: Feb. 14, 2019

(54) THE METHOD OF MANAGEMENT OF PROPERTY RIGHTS TO ASSETS AND THE SYSTEM FOR ITS IMPLEMENTATION

(71) Applicant: Tovarystvo z obmezhenoiu vidpovidalnistiu, Simcord, Kharkiv (UA)

(72) Inventor: Alexsandr Kud, Kharkiv (UA)

(21) Appl. No.: 16/068,850

(22) PCT Filed: Apr. 27, 2017
(86) PCT No.: PCT/UA2017/000050

§ 371 Date: Jul. 9, 2018

(30) Foreign Application Priority Data
Feb. 20, 2017 (UA) A 2017 01536

(51) Int. Cl. G06Q 20/36; G06Q 20/10; G06Q 40/00; G06Q 20/40; G06Q 20/38

(52) U.S. Cl. CPC G06Q 20/36; G06Q 20/10; G06Q 20/38215; G06Q 20/401; G06Q 40/00

(57) ABSTRACT

The description is related to information technologies and is intended to be used in the financial sector to execute non-cash payment transactions. The method of management of property rights to assets foresees executing a transaction and recording the completed transaction in the public distributed ledger. The transaction is executed by creating a public contract with the help of the user terminal, by sending the created public contract to the ledger object identifier generator, by creating a request by said ledger object identifier generator for publishing the record in the public distributed ledger, by validating the request for publishing the record in the validation module and publishing the record by means of the publication module in the public distributed ledger.

### CROSS-REFERENCE TO RELATED APPLICATIONS

This application is a U.S. National Phase application of PCT/UA2017/000050 filed Apr. 27, 2017, and claims priority to Australian Application No. a 2017 01536 filed Feb. 20, 2017, which are incorporated herein in their entirety by reference.

### BACKGROUND OF THE INVENTION

This group of inventions is related to information technologies and is intended to be used in the financial and law fields, for business management, management of rights to Assets, evaluation of property rights to Assets, transfer of property rights to Assets of various types including movable and immovable property, machinery and production equipment, bank deposits, copyrights, financial instruments, securities, know-how, trademarks, shares in statutory funds and in other companies, shares in various projects with legal entities and individuals and other assets.

There is a known method for confirming and transferring property right to the artworks (application for patent US 20160203572, IPC G06Q50/18, publication date Jul. 14, 2016). The method foresees creating a Bitcoin wallet (address), which consists of a public and private key, associating an artwork with a Bitcoin wallet by placing a QR code or a watermark, transferring rights to an artwork by providing the private key of Bitcoin wallet, recording the completed transfer in the open public electronic transaction ledger. The system implementing a known method includes a user terminal, open public electronic transaction ledger, which stores information only about completed transactions.

The disadvantage of the known method and of the system implementing this method is a user anonymity, which results from the Bitcoin system properties as well as from the use of the Bitcoin wallet or e-mail address, which can be created by any unidentified person. The anonymity causes the following disadvantage of the method and system—possible loss of the private key and inability to restore it. Another disadvantage is a necessity for users to contact each other via e-mail, social networks and other unreliable (unlogged) means of communication to transfer property right to an artwork. A considerable disadvantage is inability to divide property rights among several users.

There is a known digital platform for electronic calculations (application for patent US 20160292680, IPC G06Q20/40, G06Q40/06 publication date Oct. 6, 2016). The mentioned application is the closest analogue of the proposed solution. The above mentioned application also describes a method for executing a Bitcoin financial transaction, which foresees a creation of a specialized wallet including a public and private key, execution of two types of transactions (deposit/withdrawal and transfer between users), recording the completed transaction in the public open ledger.

In fact, the known digital platform is a system, which includes an interface server, user terminal, ledger designed as one or several data servers, persistent information module storing a permanent ledger fragment, cache module storing a newly created ledger fragment, authorization server, coordination module and exact time module.

The disadvantage is the centralization and redundancy of the hardware architecture being used (in particular, persistent information modules and cache modules) caused by applying a ledger with the slow processing of Bitcoin transactions. The availability of persistent information modules and cache modules, in its turn, leads to the problems of insufficient reliability, security and fault tolerance. In addition, the known system, being multi-purpose and universal, does not contain special tools and procedures for performing complex procedures for validation and reliability of transactions.

The task of this group of inventions is to increase the efficiency and functionality, security, fault tolerance, storage reliability of information on property rights to Assets by optimizing the management system of property rights to Assets and applying innovative software and hardware solutions. Also the task is to create a convenient and effective digital way of redistribution, transfer, accounting and management of property rights to Assets.

### BRIEF SUMMARY OF THE INVENTION

The set task concerning the method is achieved in such a way that in the known method of management of property rights to Assets, which foresees executing a transaction and recording the completed transaction in the public distributed ledger according to the proposed technical solution, the transaction is executed by creating a public contract with the help of the User terminal, by sending the created public contract to the ledger object identifier generator, by creating a request by said ledger object identifier generator for publishing a record in the public distributed ledger, by validating the request for publishing the record in the validation module and publishing the record by means of the publication module in the public distributed ledger.

Additionally, the method includes forming a request by means of the User terminal to transfer an identifier of the digital derivative financial instrument that corresponds to a certain part of the property rights to Assets, transferring the generated request to the transaction processing module that executes the request processing in accordance with certain rules until the predetermined event occurs with a possibility to limit the field of application, validating the request in the validation module, creating an identifier of the record on the redistribution or transfer of property rights to Assets by the ledger object identifier generator and publishing this record by means of records publication module in the public distributed ledger.

The set task concerning the system is achieved in such a way that in the known management system of property rights to Assets, which includes a network of hardware-software complexes containing a public distributed ledger, data on nominal value, User identifiers, data on transaction history, exact time module, transaction processing module, publication module, in accordance with the declared technical decision the public distributed ledger contains data on User accounts, public contract, evaluation of nominal value of property rights to Assets, the system contains a ledger object identifier generator configured as a separate device with the ability to interact with the exact time module using cryptographic algorithms for data processing, transaction processing module configured with the ability to process a request to form a record on the transfer or redistribution of property rights to Assets in the public distributed ledger, and also in such a way that the system contains a validation module that is configured with the ability to verify the correctness of the evaluation results of property rights to Assets, public contract, nominal value and User identifiers.

In addition, the exact time module is configured with the ability to synchronize with the network-wide time of the hardware-software complexes network, which differs from the global time due to the considered speed corrections of the signal propagation across the network segments between the hardware-software complexes.

The technical result of the claimed method is the creation of a convenient and effective digital way of redistribution, transfer, accounting and management of property rights to Assets.

The technical result of the declared system is an increase in the efficiency and functionality, security, fault tolerance, storage reliability of information on property rights to Assets by including the ledger object identifier generator and the validation module in the system, by creating the possibility of digital transfer of property rights to Assets.

In addition, the transparency of the transfer of property rights to Assets and of the management of property rights to Assets is increased by providing the possibility of free access to the public distributed ledger of property rights to Assets for data reading by Users.

The information storage reliability of property rights to Assets is improved through the storage of data in the public distributed ledger of property rights to Assets that can be implemented on such platforms as IBM HyperLedger, Ethereum, Ripple and others.

It is possible to automatically register all transactions with property rights to Assets by recording them in the public distributed ledger.

The universality of data transfer interfaces is achieved by using publicly available data transfer tools based on Open Source solutions.

The unification of processes of collecting, consolidating and storing data is achieved by applying an open standards system.

### BRIEF DESCRIPTION OF THE DRAWINGS

The declared system is illustrated with the drawings:

FIG. 1 is a schematic illustrating the interaction of an example of the system components at the stage of Bitbon creation;

FIG. 2 is a schematic illustrating the interaction of an example of the system components at the stage of Bitbon transfer.

FIG. 3 is a schematic illustrating the interaction of an example of the system components when working with various financial institutions.

### DETAILED DESCRIPTION

### Glossary of Terms Used in the Document

User means an individual i.e. a person, a participant of civil and other legal relations (holder of rights and obligations), or a Company (legal entity registered and operating in accordance with the requirements of jurisdiction of which it is a taxpayer), or a Company consolidation (different kinds of Company consolidations registered and operating in accordance with the requirements of jurisdiction of which it is a taxpayer).

Account means a collection of User data necessary for his/her authentication and for providing access to his/her personal details, settings and the system functionality.

Assets mean property that is legally owned by the User, including: real estate, bank deposits, machinery and production equipment, securities, patents, trademarks, know-how, shares in statutory funds and in other companies, shares in various projects with legal entities and individuals, Bitbon of another User and other assets.

Bitbon means a digital derivative financial instrument having an identifier and nominal value in the amount determined in accordance with the procedure stipulated by Bitbon Public Contract, which corresponds to a certain part of property rights to Assets. Any operations with Bitbon (Bitbon issuing, its transfer from one owner to another, splitting of nominal value and other operations) are recorded in the public distributed ledger as data that cannot be deleted or modified.

Bitbon Public Contract means a digital document that defines and regulates the field of Bitbon application, as well as all products and operations that may be applied to Bitbon. The Bitbon Public Contract can define the terms and procedures for Bitbon issuing, Bitbon transfer rules, procedure for repurchasing Bitbon from Users, as well as the link to the procedure for evaluating Assets.

Bitbon attributes are:

Identifier—a unique sequence of alphabetic and numeric characters;

Nominal value—a positive real number corresponding to the part of the User's property rights to Assets;

Records in the public distributed ledger, which register all operations with each Bitbon;

Bitbon Public Contract.

In addition, Bitbon has the following properties:

The ability to split the nominal value with unlimited accuracy is guaranteed. Each fractional part of the nominal value corresponds to a certain part of property rights to Assets;

Bitbon is issued in accordance with the Bitbon Public Contract published by the User based on the decision of Bitbon issuing;

Bitbon can be used as a tool for trading on the exchange;

Bitbon can be used for calculating the index or any other financial derivatives, instruments;

Bitbon of one User may serve as an Asset of another User;

It is guaranteed that any part of the Bitbon nominal value in the form of a new identifier is transferred from one User to another User;

Ability to define rules of Bitbon processing before the occurrence of an event which the User specifies limiting the Bitbon application field.

The system for implementing the management method of property rights to Assets contains the following components.

The public distributed ledger 1 of data on nominal value, on User identifiers, on transaction history, on the Bitbon Public Contract, on the evaluation of nominal value of property rights to Assets, on User Accounts is a network of hardware-software complexes (HSCs), where each HSC is connected to all other HSCs that are part of the network. Each HSC contains a memory and processor. An example of such HSCs can be: a personal computer, smartphone, dedicated server, tablet computer and other types of devices. The memory of each device contains the data of the public distributed ledger 1, which is synchronized with other network devices. In such a case, the failure of one of the devices will not lead to the loss of records on property rights to Assets, information on owners and transactions. The public distributed ledger 1 is configured with the ability to interact with the User terminal 7 and the publication module 6.

The exact time module 2 is configured with the ability to synchronize with the network-wide time of the HSC network, which differs from the global time due to the considered speed corrections of the signal propagation across the network segments between HSCs. It is a hardware-software device, which includes a free-running hardware time counter adjusted to ensure the network time uniformity on all HSCs using the network interfaces of the Internet. The network time uniformity is achieved by taking into account inaccuracy between the system time of HSCs and the global time related to the speed of signal propagation across the local network segments connecting HSCs to each other.

The exact time module 2 is configured with the ability to interact with the ledger object identifier generator 3, transaction processing module 4, validation module 5, publication module 6.

The ledger object identifier generator 3 is a separate device using cryptographic algorithms to generate hash codes based on elliptic curves using a generator of random numbers implemented on the basis of a separate hardware solution, which ensures the required cryptographic quality of hash functions.

The ledger object identifier generator 3 is configured with the ability to interact with the User terminal 7, transaction processing module 4, validation module 5, exact time module 2.

The transaction processing module 4 is designed to perform the request processing procedure to form a record on the redistribution or transfer of property rights to Assets in the public distributed ledger 1. It is one or several HSCs.

The transaction processing module 4 is configured with the ability to interact with the User terminal 7, ledger object identifier generator 3, exact time module 2, validation module 5, publication module 6.

The validation module 5 is characterized by the ability to verify the correctness and reliability of the evaluation results of property rights to Assets, Bitbon Public Contract, nominal value, User identifiers. It is one or several HSCs with the implemented ability to interact with the ledger object identifier generator 3, transaction processing module 4, exact time module 2 and publication module 6.

The publication module 6 is characterized by the ability to publish new records in the public distributed ledger 1. It is one or several HSCs with the implemented ability to interact with the object identifier generation module 3, transaction processing module 4, exact time module 2, public distributed ledger 1. Only the publication module 6 is entitled to record in the public distributed ledger 1.

The User terminal 7 is characterized by the ability to create the Bitbon Public Contract, create an order to transfer property rights to Assets. It is a HSC with the implemented ability to interact with the ledger object identifier generator 3, transaction processing module 4 and public distributed ledger 1 with free access to data reading.

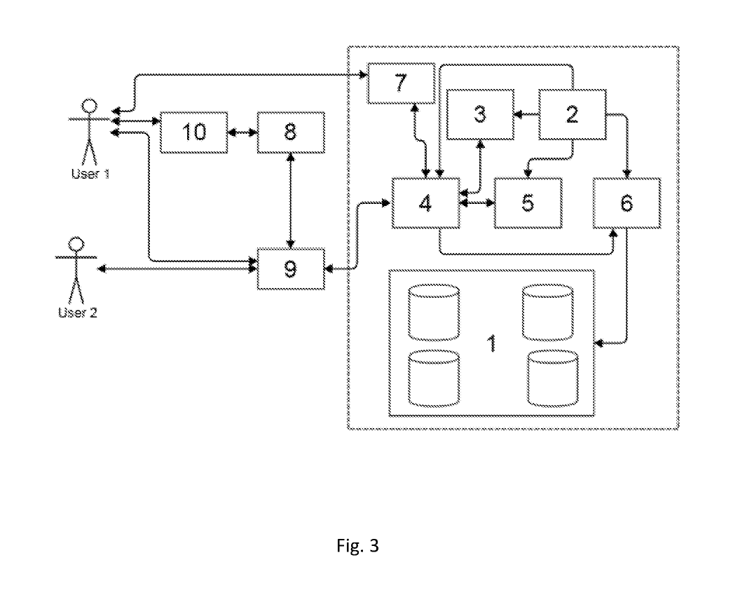

In FIG. 3 positions 8, 9, 10 respectively indicate components that are not parts of the declared system: Financial Institution (Acquirer) 8, Exchange 9, Store 10.

Let us consider the implementation of the claimed method using the declared system described above.

### EXAMPLE 1

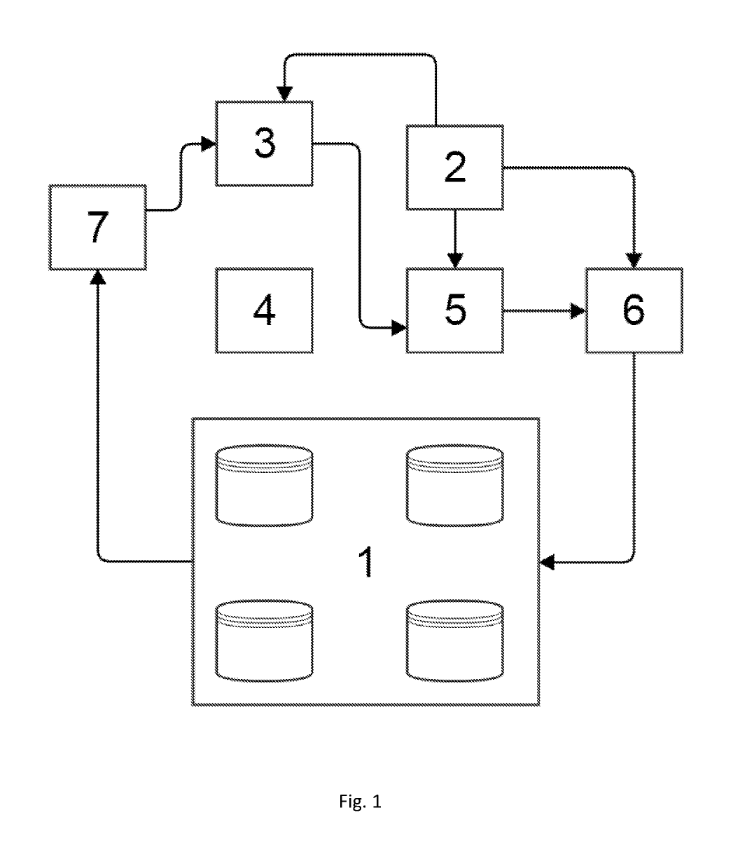

### Evaluation and Issuing of Bitbon as Property Rights to Assets (See FIG. 1)

1.1. By using terminal 7 the User (owner of Assets) creates the Bitbon Public Contract, in which he/she defines the field of Bitbon application and regulates all procedures and operations that can be applied to Bitbon. The Bitbon Public Contract can determine Bitbon issuing procedure, Bitbon transfer rules, procedure for repurchasing Bitbon from their owners, Bitbon exchange procedure for part of Assets as well as the link to the procedure for evaluating User's Assets.

1.2. The User sends the created Bitbon Public Contract to the ledger object identifier generator 3, which generates a Bitbon identifier and request for recording it in the public distributed ledger 1 arriving at the validation module 5. If the validation fails, a notification is sent to the User that it is impossible to issue Bitbon. If the generated request is validated, it is transmitted to the publication module 6, which in its turn, based on the evaluation results forms the nominal value of issuable Bitbon and makes a record containing information on Bitbon Public Contract, quantity and nominal value of Bitbon and evaluation results in the public distributed ledger 1.

1.3. Each HSC of the public distributed ledger 1, which contains software that can be used to record operations with Bitbon, will send a request for execution to the nearest network device, the processor of which will form a record of the operation, save the record in memory and distribute it among other devices included in the HSC network. Being saved in the memory of a device and being distributed in the HSC network, the record cannot be deleted or modified. Built-in security facilities will ensure uniqueness, reliability and integrity of the record on operations at all stages of formation and distribution. In case of unavailability of one or several HSCs in the network all records remain available, the HSC network continues to function in full, HSCs also become fully functional upon gaining access to the network. Any data block can be selected from the public distributed ledger 1 through the Internet using specialized software as well as through public interfaces based on Open Source software.

### EXAMPLE 2

### Evaluation, Accounting and Control of Assets Usuing Bitbon

2.1. To evaluate, keep records and control Assets using Bitbon, you should issue Bitbon as described above in example 1. The Bitbon Public Contract specifies that the created Bitbon is created solely for evaluation, accounting and control, so its transfer will not lead to the transfer of property rights to Assets.

2.2. In accordance with the evaluation procedure, User's Assets are presented as a hierarchy or a set of departments, each of which is evaluated by one or more indicators. An Account is created for each department-indicator pair. Based on the evaluation results, when creating Bitbon for each Account, the User (Bitbon owner) using the terminal 7 generates a request to transfer Bitbon nominal value in proportion to the evaluation of Assets to this Account.

2.3. The request is sent to the transaction processing module 4, which processes the request by validating the request on the validation module 5. If the validation fails, a Bitbon transfer error message is sent to the User. If the request is validated, the transaction processing module 4 receives an identifier of Bitbon record from the ledger object identifier generator 3. The transaction processing module 4 receives the correct date and time of recording from the exact time module 2. The generated request is transmitted to the publication module 6, which in its turn, publishes a record containing nominal value of adjustable Bitbon and the evaluation results in the public distributed ledger 1.

2.4. After a certain period of time according to the evaluation procedure indicated in the Bitbon Public Contract, the User evaluates the current state of Assets. As a result of this evaluation the difference between the evaluation of this department according to this indicator and the current Bitbon nominal value is determined in the corresponding Account. The User (Bitbon owner) generates a request to adjust Bitbon nominal value in this Account by transferring a part of Bitbon from/to this Account in accordance with Clause 2.3.

2.5. At any time, the parties concerned can receive the whole sequence of changes of Bitbon nominal value in the Accounts, which are recorded over any period of Bitbon existence with the help of specialized software or with the help of Open Source software using public standard interfaces from the public distributed ledger 1.

### EXAMPLE 3

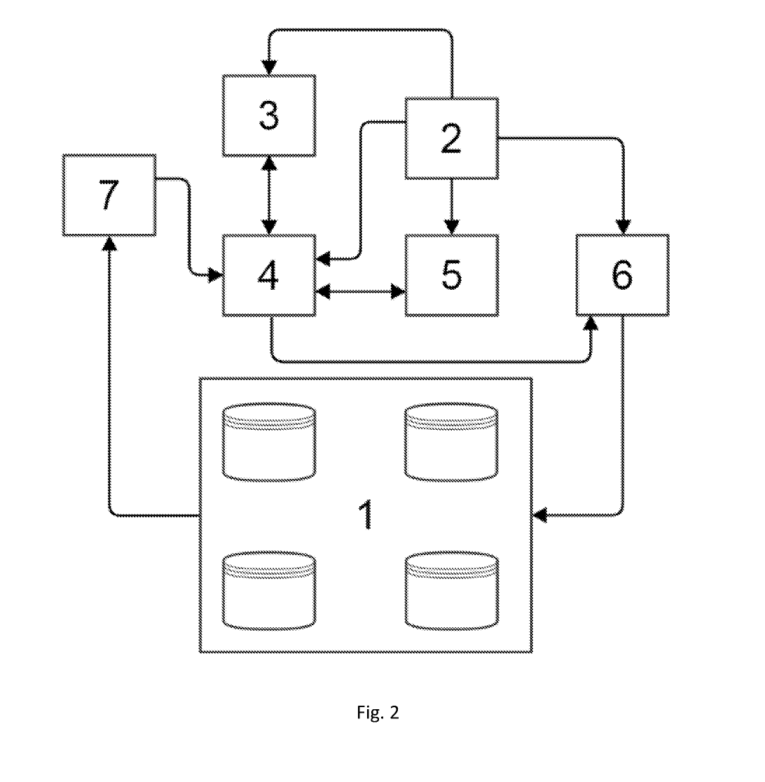

### Transfer of Property Rights to Assets Using Bitbon (See FIG. 2)

3.1. Before you transfer property rights to Assets using Bitbon, you should issue Bitbon as described above in example 1.

3.2. The User (Bitbon owner) willing to transfer Bitbon by means of the terminal 7 generates a request to transfer Bitbon to another User (Bitbon recipient) according to the Bitbon Public Contract.

3.3. The request is sent to the transaction processing module 4, which validates the request on the validation module 5. If the validation fails, the User is notified of transfer error of Bitbon nominal value. If the request is validated, module 4 receives an identifier of Bitbon record from the ledger object identifier generator 3. The module 4 receives the correct date and time of recording from the exact time module 2. The generated request is transmitted to the publication module 6, which, in its turn, based on the evaluation results publishes a record with the nominal value of Bitbon being transferred to the public distributed ledger 1.

### EXAMPLE 4

### Bitbon Exchange for Goods (See FIG. 3)

4.1. User 1 (Bitbon owner) willing to receive goods in Store 10, requests the authorization code through the terminal 7.

4.2. User 1 informs Store 10 of the authorization code.

4.3. Store 10 initiates the transaction by sending the authorization code to the Financial Institution (Acquirer) 8, indicating the cost of goods.

4.4. The User sends a request and the authorization code to Exchange 9 to sell the required Bitbon nominal value for the specified currency.

4.5. Exchange 9 accepts a request for exchange and selects an offer registered on Exchange 9 from another User (User 2) willing to purchase Bitbon for the specified currency.

4.6. Exchange 9 sends a request to transfer Bitbon from User Account 1 to User Account 2 using the transaction processing module 4.

4.7. The request is sent to the transaction processing module 4, which verifies the request compliance with the following conditions:

processing rules (term of execution, price deviation, etc.);

event (up to a certain date, etc.);

field of application (only a specific type of product, etc.) and validates the request on the validation module 5.

4.8. If the validation of the request fails, the User is notified that Bitbon cannot be transferred.

4.9. If the request is validated, the module 4 receives an identifier of Bitbon record from the ledger object identifier generator 3. The transaction processing module 4 receives the correct date and time of recording from the exact time module 2.

4.10. The generated request is transmitted to the publication module 6, which in its turn, publishes a record on the Bitbon transfer with the specified nominal value from User 1 to User 2 in the public distributed ledger 1.

4.11. Exchange 9 receives confirmation of the transaction execution from the transaction processing module 4 and transfers funds from User 2 to the Financial Institution (Acquirer) 8.

4.12. Financial Institution 8 confirms the transaction to Store 10.

4.13. Store 10 transfers goods to User 1.

### EXAMPLE 5

### Fundraising for Project Implementation (See FIG. 3)

5.1. To raise funds for the project implementation using Bitbon, User 1 (project initiator) should issue Bitbon as described in example 1 above. The Bitbon Public Contract specifies the purpose of fundraising, as well as rules and conditions for using funds and their accounting.

5.2. User 1 places an offer to sell created Bitbon on Exchange 9.

5.3. User 2 willing to transfer his/her funds for the project implementation purchases the desired Bitbon nominal value on Exchange 9.

5.4. Exchange 9 sends a request to transfer Bitbon from User Account 1 to User Account 2 using the transaction processing module 4.

5.5. The request is sent to the transaction processing module 4, which processes the request by validating the request on the validation module 5.

5.6. If the validation fails, a Bitbon transfer error notification is given.

5.7. If the request is validated, the transaction processing module 4 receives an identifier of Bitbon record from the ledger object identifier generator 3. The transaction processing module 4 receives the correct date and time of recording from the exact time module 2.

5.8. The generated request is transmitted to the publication module 6, which in its turn, publishes a record on the Bitbon transfer with the specified nominal value from User Account 1 to User Account 2 in the public distributed ledger 1.

5.9. Exchange 9 receives confirmation of the transaction execution from the transaction processing module 4 and transfers funds from User 2 to User 1.

We claim:

1. A system of management of property rights to assets, the system comprising:
a controller;
a memory coupled to the controller, wherein the memory is configured to store program instructions executable by the controller;
wherein in response to executing the program instructions, the controller is configured to:
receive public contract information from a user terminal, wherein the public contract is associated with at least a portion of a property right associated with a digital derivative financial instrument;
create a public contract based on the public contract information;
send the created public contract to a ledger object identifier generator;
create a publishing request for publishing a record in a public distributed ledger via the ledger object identifier generator; and
upon receiving a validation of the request for publishing the record, publish the record via a publication module in the public distributed ledger.

2. The system of claim 1, wherein the controller is further configured to receive an identifier, via the user terminal, wherein the identifier corresponds to the at least a portion of a property right associated with the digital derivative financial instrument;
create a transfer request to transfer the property right associated with the digital derivative financial instrument, wherein the transfer request is associated with the user identifier;
transfer the transfer request to a transaction processing module;
process the transfer request, via the processing module;
create a transaction identifier of the processed record, via a ledger object identifier generator; and
publish the processed record, via the publication module.

3. The system of claim 1, wherein the public distributed ledger includes transaction history data associated with a plurality of user identifiers, wherein the transaction history data includes a transaction value and a time of transaction.

4. The system of claim 1, wherein the public distributed ledger includes user account information associated with each user identifier, and an evaluation of a nominal value of the property right asset associated with each user identifier.

5. The system of claim 1, wherein the ledger object identifier generator is configured as a separate device in communication with the controller, wherein the ledger object identifier generator uses cryptographic algorithms in creating the identifier of the processed record.

6. The system of claim 1, wherein the controller is further configured to process a transaction via a transaction processing module configured to process a request to generate a transfer record on the transfer of property rights, wherein the controller is configured to record the transfer record in the public distribution ledger.

7. The system of claim 1, wherein the controller is further configured to evaluate the value of the portion of a property right associated with the digital derivative financial instrument.

8. The system of claim 1, wherein the controller is further configured to synchronize time with an external exact time module, wherein the external exact time module maintains uniform time among a network of a plurality of controllers.

9. A method of managing property rights of assets, the method comprising:
receiving public contract information from a user terminal wherein the public contract is associated with at least a portion of a property right associated with a digital derivative financial instrument;
creating a public contract based on the public contract information;
sending the created public contract to a ledger object identifier generator;
creating a request for publishing a record in a public distributed ledger via the ledger object identifier generator; and
upon receiving a validation of the publishing request for publishing the record, publishing the record via a publication module in the public distributed ledger.

10. The method of claim 9, further comprising,
receiving an identifier, via the user terminal, wherein the identifier corresponds to at least a portion of a property right associated with a digital derivative financial instrument;
creating a transfer request to transfer the property right associated with the digital derivative financial instrument, wherein the transfer request is based on the user identifier;
transferring the transfer request to a transaction processing module;
processes the transfer request via the transaction processing module;
validating the transfer request, via a validation module;
creating a transaction identifier of the processed record, via a ledger object identifier generator; and
publishing the processed record, via the publication module.

11. The method of claim 9, wherein the public distributed ledger includes transaction history data associated with a plurality of user identifiers, wherein the transaction history data includes transaction value and time of transaction.

12. The method of claim 9, wherein the public distributed ledger includes user account information associated with each user identifier, an evaluation of nominal value of the property right asset associated with each user identifier.

13. The method of claim 9, wherein the ledger object identifier generator is configured as a separate device in communication with the controller, wherein the ledger object identifier generator uses cryptographic algorithms in creating the identifier of the processed record.

14. The method of claim 9, further comprising
processing a transaction via a transaction processing module configured to process a request to generate a record on the transfer of property rights to the public distribution ledger; and
record the transfer record in the public distribution ledger.

15. The method of claim 9, further comprising evaluating the value of the portion of a property right associated with the digital derivative financial instrument.

16. The method of claim 9, further comprising an exact time module configured to synchronize with a network-wide time, wherein the external exact time module maintains uniform time among a network of a plurality of controllers.
